(19) United States
(12) Patent Application Publication
(10) Pub. No.: US 2012/0097692 A1
(43) Pub. Date: Apr. 26, 2012

(54) Support Device that will not Produce Holes in a Wall

(76) Inventor: Man-Chu Wang, Yuanlin Township (TW)

(21) Appl. No.: 13/238,215

(22) Filed: Sep. 21, 2011

(30) Foreign Application Priority Data
Oct. 25, 2010 (CN) 201020577577.6

(51) Int. Cl. B65D 90/12; A47K 10/04; A47G 29/00; F16B 47/00

(52) U.S. Cl. 220/737; 248/205.3; 211/45; 211/71.01

(57) ABSTRACT

A support device includes at least one fixture and at least one support member connected with the fixture. The fixture includes an intermediate layer, an adhesive layer mounted on a first surface of the intermediate layer, a printing layer mounted on the adhesive layer, an outer layer mounted on the printing layer, a bonding layer mounted on a second surface of the intermediate layer, and a releasing layer mounted on the bonding layer. Thus, the bonding layer of the fixture is directly bonded onto a smooth surface to attach the fixture to the smooth surface without having to nail or drill the smooth surface so as to prevent from producing holes on the smooth surface.

### BACKGROUND OF THE INVENTION

1. Field of the Invention

The present invention relates to a support device and, more particularly, to a support device for supporting articles, such as towels, cups, soaps, cell phones and the like.

2. Description of the Related Art

A conventional support device in accordance with the prior art shown in FIG. 8 comprises two mounting members 21 and a support rack 20 mounted between the two mounting members 21. The two mounting members 21 are mounted on a wall by a plurality of fastening screws 22 so as to attach the support rack 20 to the wall. However, the fastening screws 22 are screwed into the wall to produce multiple holes in the wall, so that when the support device are removed from the wall, the holes are exposed outward from the wall, thereby greatly decreasing the aesthetic quality of the wall.

### BRIEF SUMMARY OF THE INVENTION

In accordance with the present invention, there is provided a support device, comprising at least one fixture and at least one support member connected with the fixture. The fixture includes an intermediate layer, an adhesive layer mounted on a first surface of the intermediate layer, a printing layer mounted on the adhesive layer, an outer layer mounted on the printing layer, a bonding layer mounted on a second surface of the intermediate layer, and a releasing layer mounted on the bonding layer.

The primary objective of the present invention is to provide a support device that will not produce holes in a wall.

According to the primary advantage of the present invention, the bonding layer of the fixture is directly bonded onto a smooth surface to attach the fixture to the smooth surface without having to nail or drill the smooth surface so as to prevent from producing holes on the smooth surface.

According to another advantage of the present invention, the bonding layer of the fixture can be removed from the smooth surface and will not dirty the smooth surface to facilitate a user removing the fixture.

According to a further advantage of the present invention, the bonding layer of the fixture can be removed and reused easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a support device in accordance with the preferred embodiment of the present invention.

FIG. 2 is an exploded perspective view of the support device as shown in FIG. 1.

FIG. 3 is a side cross-sectional view of the support device as shown in FIG. 1.

FIG. 4 is a schematic operational view of the support device as shown in FIG. 3 in use.

FIG. 5 is a schematic operational view of the support device as shown in FIG. 1 in use.

FIG. 6 is a perspective view of a support device in accordance with another preferred embodiment of the present invention.

FIG. 7 is a perspective view of a support device in accordance with another preferred embodiment of the present invention.

FIG. 8 is an exploded perspective view of a conventional support device in accordance with the prior art.

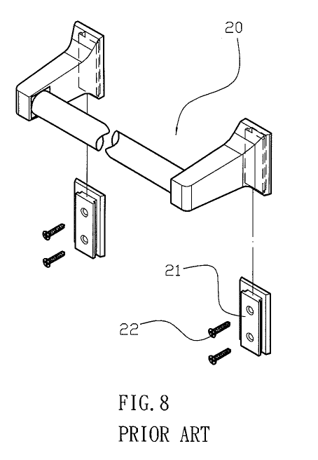

### DETAILED DESCRIPTION OF THE INVENTION

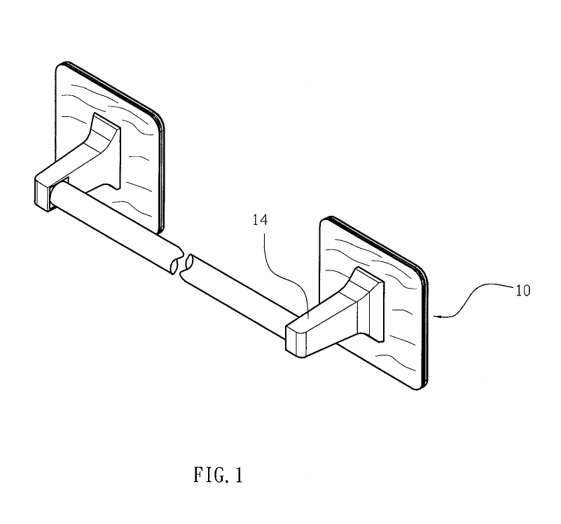

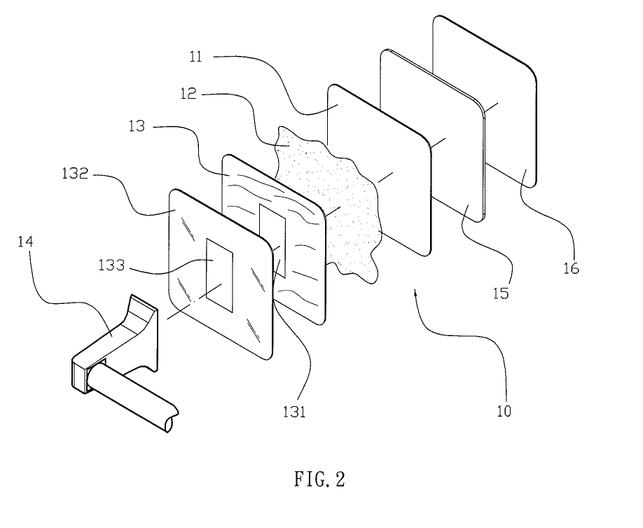

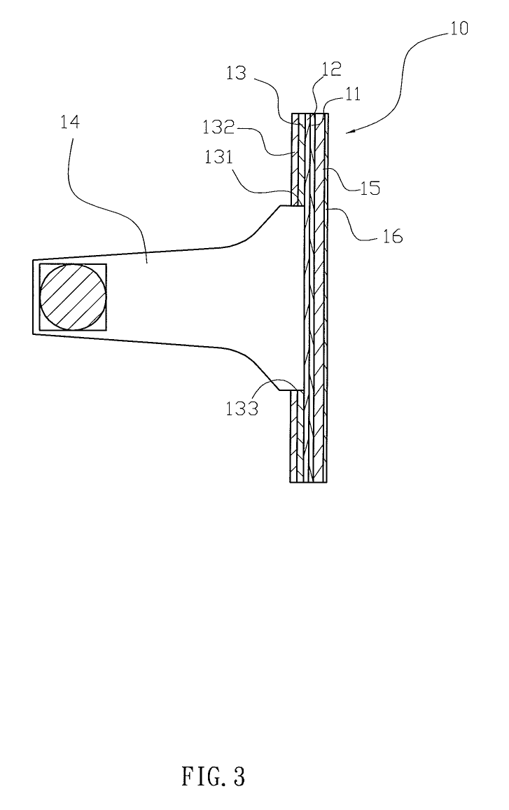

Referring to the drawings and initially to FIGS. 1-3, a support device in accordance with the preferred embodiment of the present invention comprises at least one fixture 10 and at least one support member 14 connected with the fixture 10.

The fixture 10 includes an intermediate layer 11, an adhesive layer 12 mounted on a first surface of the intermediate layer 11, a printing layer 13 mounted on the adhesive layer 12, an outer layer 132 mounted on the printing layer 13, a bonding layer 15 mounted on a second surface of the intermediate layer 11, and a releasing layer 16 mounted on the bonding layer 15.

The intermediate layer 11 of the fixture 10 is a piece of synthetic paper that is made of PP (polypropylene) material. The printing layer 13 of the fixture 10 is bonded onto and combined with the intermediate layer 11 by doping of the adhesive layer 12. The printing layer 13 of the fixture 10 has a surface provided with an opening 131 to allow passage of the support member 14. The outer layer 132 of the fixture 10 is made of a transparent material to protect the printing layer 13 and has a surface provided with an opening 133 to allow passage of the support member 14.

The bonding layer 15 of the fixture 10 is made of a resilient gel, such as a SEBS (styrene ethylene butadiene styrene) gel, so that the bonding layer 15 of the fixture 10 is bonded onto a smooth surface easily and closely so as to attach the fixture 10 to the smooth surface.

The support member 14 is extended through the opening 133 of the outer layer 132 of the fixture 10 and the opening 131 of the printing layer 13 of the fixture 10. The support member 14 is bonded onto the adhesive layer 12 of the fixture 10 and is combined with the intermediate layer 11 by the adhesive layer 12 of the fixture 10. Preferably, the support member 14 is a towel rack that is made of metallic material or nonmetallic material.

In the preferred embodiment of the present invention, the support device comprises two fixtures 10 and a support member 14 connected between the two fixtures 10.

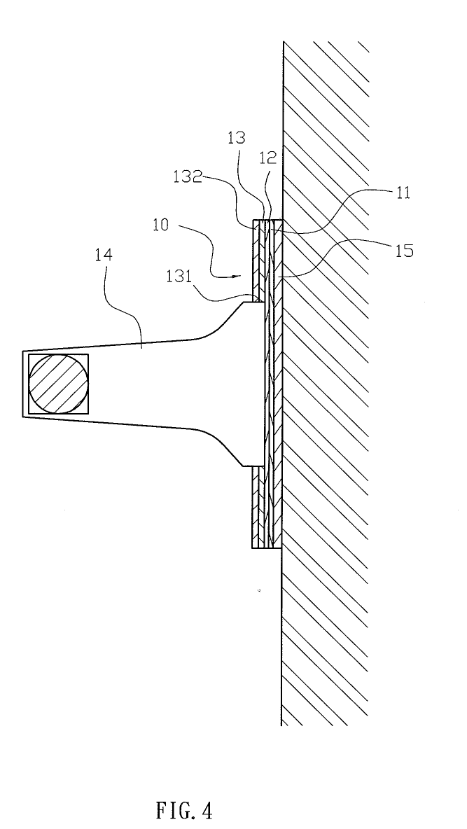

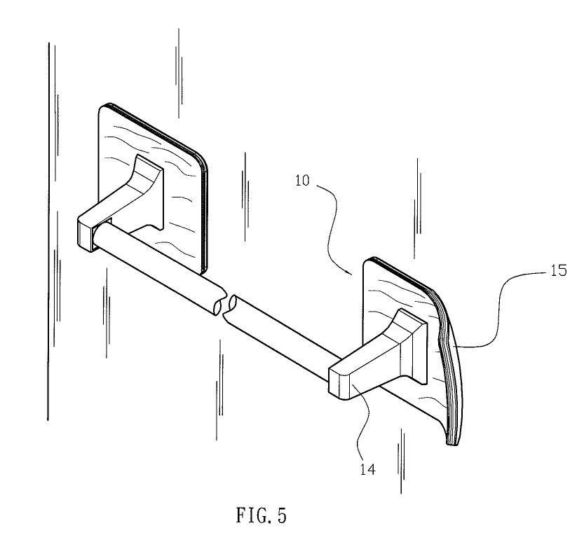

In operation, referring to FIGS. 4 and 5 with reference to FIGS. 1-3, the releasing layer 16 of the fixture 10 is stripped to expose the bonding layer 15. Then, the bonding layer 15 of the fixture 10 is bonded onto a wall so as to attach the fixture 10 to the wall easily and closely. In such a manner, the bonding layer 15 of the fixture 10 can isolate the moisture of the wall efficiently to prevent the moisture from infiltrating between the wall and the bonding layer 15 of the fixture 10 so that the bonding layer 15 of the fixture 10 is bonded onto the wall solidly and stably. In addition, the bonding layer 15 of the fixture 10 can be removed from the wall and can be bonded onto another smooth surface so that the fixture 10 can be reused.

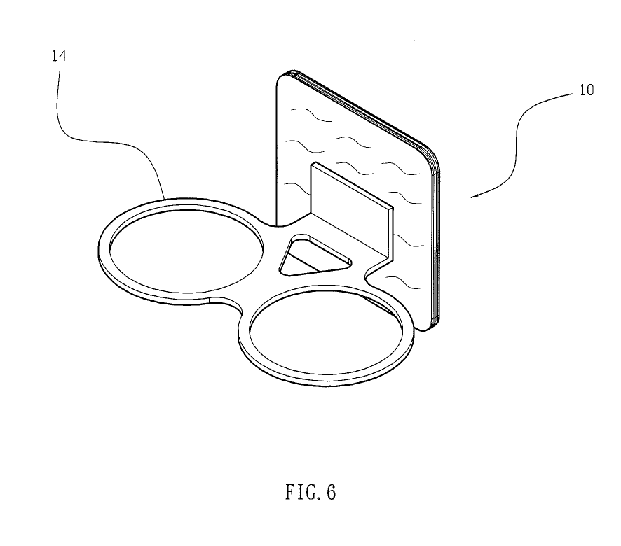

As shown in FIG. 6, the support member 14 is a cup rack to support cups.

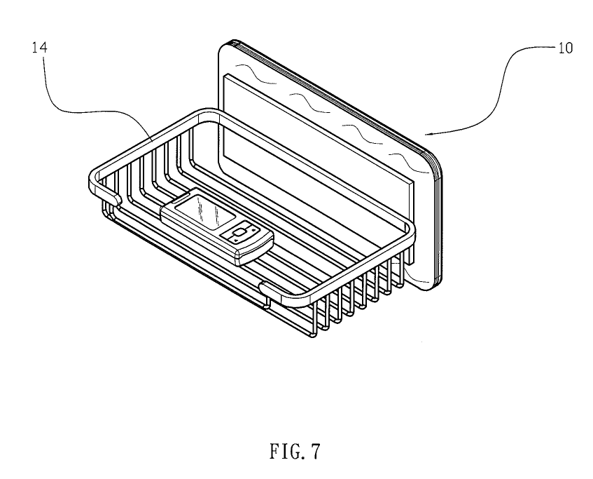

As shown in FIG. 7, the support member 14 is a basket to support an item, such as a cell phone, soap and the like.

Accordingly, the bonding layer 15 of the fixture 10 is directly bonded onto a smooth surface to attach the fixture 10 to the smooth surface without having to nail or drill the smooth surface so as to prevent from producing holes on the smooth surface. In addition, the bonding layer 15 of the fixture 10 can be removed from the smooth surface and will not dirty the smooth surface to facilitate a user removing the fixture 10. Further, the bonding layer 15 of the fixture 10 can be removed and reused easily and quickly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A support device, comprising:
at least one fixture; and
at least one support member connected with the fixture;
wherein the fixture includes:
an intermediate layer;
an adhesive layer mounted on a first surface of the intermediate layer;
a printing layer mounted on the adhesive layer;
an outer layer mounted on the printing layer;
a bonding layer mounted on a second surface of the intermediate layer; and
a releasing layer mounted on the bonding layer.

2. The support device of claim 1, wherein the bonding layer of the fixture is made of a resilient gel.

3. The support device of claim 2, wherein the bonding layer of the fixture is made of a SEBS (styrene ethylene butadiene styrene) gel.

4. The support device of claim 1, wherein the intermediate layer of the fixture is a piece of synthetic paper that is made of PP (polypropylene) material.

5. The support device of claim 1, wherein the printing layer of the fixture has a surface provided with an opening to allow passage of the support member.

6. The support device of claim 5, wherein the outer layer of the fixture has a surface provided with an opening to allow passage of the support member.

7. The support device of claim 6, wherein the support member is extended through the opening of the outer layer of the fixture and the opening of the printing layer of the fixture.

8. The support device of claim 1, wherein the printing layer of the fixture is bonded onto and combined with the intermediate layer by doping of the adhesive layer.

9. The support device of claim 1, wherein the support member is bonded onto the adhesive layer of the fixture.

10. The support device of claim 9, wherein the support member is combined with the intermediate layer by the adhesive layer of the fixture.

11. The support device of claim 1, wherein the support member is made of metallic material.

12. The support device of claim 1, wherein the support member is made of nonmetallic material.

13. The support device of claim 1, wherein the support device comprises two fixtures and a support member connected between the two fixtures.

14. The support device of claim 1, wherein the support member is a towel rack.

15. The support device of claim 1, wherein the support member is a cup rack.

16. The support device of claim 1, wherein the support member is a basket.
